(19) United States
(12) Patent Application Publication
(10) Pub. No.: US 2004/0256776 A1
(43) Pub. Date: Dec. 23, 2004

(54) Load assisting system for mechanical lever assemblies

(76) Inventor: Larry Brian Champ, Cairo, MO (US)

Correspondence Address: MICHAEL K. BOYER, ORSCHELN MANAGEMENT CO, 2000 US HWY 63 SOUTH, MOBERLY, MO, 65270, US

(21) Appl. No.: 10/732,607

(22) Filed: Dec. 9, 2003

Related U.S. Application Data
(60) Provisional application No. 60/432,062, filed on Dec. 9, 2002.

(51) Int. Cl. F16F 5/00

(52) U.S. Cl. 267/64.12

(57) ABSTRACT

The disclosure relates to a parking brake system that includes a dampening and load assisting system. The system employs a gas spring that can both reduce the load required to operate the system, and dampen the release. The system comprises a fluid dampener that accumulates a releasable load (e.g,. a “gas spring”).

### CROSS REFERENCE TO RELATED PATENTS AND PATENT APPLICATIONS

The subject matter herein is related to U.S. patent application Ser. No. 10/160,209, filed on May 30, 2002, in the name of Larry Brian Champ and entitled “Controlled Release Parking Brake Systems”; the disclosure of which is hereby incorporated by reference.

This Application claims benefit of Provisional U.S. Patent Application Ser. No. 60/432,062, filed on Dec. 09, 2002. The disclosure of Ser. No. 60/432,062 is hereby incorporated by reference.

### FIELD OF THE INVENTION

The instant invention relates to a controlled release parking brake system comprising a parking brake lever (either foot or hand operated), a dampening system, at least one cable and a connection to a conventional braking system operated by the cable. The assembly can be employed to control the release of a parking brake on a wide range of vehicles such as passenger cars, all terrain vehicles, lawn equipment and tractors, trucks (e.g., Class 5-7), utility cars, among other applications wherein it is desirable to have controlled application and release of mechanical energy or force.

### BACKGROUND OF THE INVENTION

Conventional parking brake assemblies are either hand or foot actuated and are used by an operator to tension a cable and in turn operate a parking brake. In the case of a foot operated assembly one end of a parking brake lever includes a foot pedal whereas in a hand operated assembly one end of the parking brake lever will typically include a release button. Examples of hand or foot operated parking brake systems are described in U.S. Pat. Nos. 5,309,786; 5,462,146; 5,528,956; 5,875,689; and 5,75,688; hereby incorporated by reference.

When a conventional parking brake assembly is applied, the parking brake lever is displaced to an engaged position. When conventional parking brake assemblies are disengaged, the energy of the system is released thereby permitting a parking brake lever to travel to a disengaged position. In some cases if the parking brake is disengaged or released in an uncontrolled manner, components of the parking brake assembly such as the parking brake lever as well as adjoining systems (e.g., instrument panel), may be damaged (e.g, caused when the parking brake lever impacts its released position). The degree of any damage can be increased when a vehicle operator applies additional force when releasing the parking brake (known as “slam off”).

When a conventional parking brake assembly is applied, the parking brake lever is typically displaced by the vehicle operator. That is, the parking brake assembly is displaced manually (e.g., either by foot or hand). An assembly that is difficult to apply is undesirable for many vehicle operators.

There is a need in this art for a parking brake assembly wherein the parking brake is released in a controlled fashion that minimizes damage to components of the parking brake assembly (e.g., parking brake lever). There is also a need in this art for parking brake assembly wherein the parking brake can be applied in a manner requiring a relatively low amount of force.

### SUMMARY OF THE INVENTION

The instant invention solves problems associated with convention parking brake systems by providing a dampening and load assisting system (hereinafter “system”). The inventive system employs a gas spring that can both reduce the load required to operate the system, and dampen the release. The system comprises a fluid dampener that accumulates a releasable load (e.g,. a “gas spring” comprising a rod and a hollow cylinder). The fluid can comprise at least one compressible gas (e.g., air, nitrogen, etc.) and optionally at least one liquid (e.g., hydraulic oil).

The system is located within the parking brake system in a manner sufficient to control the release of the parking brake lever into a disengaged or released position, and reduce the force required to move the lever into an engaged position. The system assists in application of the parking brake lever by reducing the load necessary to move the lever.

In one aspect of the invention, the system (e.g., gas spring) is added to the assembly between a fixed location such as the mounting bracket and the moving part of the mechanism. The assembly is arranged so that the spring function of the system will allow the mechanism to travel toward the disengaged position in a controlled fashion, but when the lever is moved into the on/applied position the gas spring will provide a force that will reduce the operator effort (e.g., parking brake systems function such that the cable load is small in the off position and increases as the lever moves towards the applied/engaged position).

### BRIEF DESCRIPTION OF THE DRAWINGS

FIGS. 1A-1C illustrate one aspect of the instant invention wherein the parking brake assembly is in an applied or engaged position.

FIGS. 2A-2B illustrate the aspect of the invention shown in FIGS. 2A-2C in a released or disengaged position.

FIG. 3 illustrates the dampening and load assisting system shown in FIGS. 1 and 2.

Dimensions shown in these Figures are for illustration purposes only and do not limit the scope of the appended claims, or the size or relative dimensions of an apparatus embodying the invention.

### DETAILED DESCRIPTION

The instant invention relates to a controlled release parking brake system comprising a parking brake lever (either foot or hand operated), and a dampening system. The parking brake system can further comprise at least one cable and a connection to a conventional braking system operated by the cable. The dampening system can be employed on any suitable conventional hand or foot operated parking brake system.

Any suitable dampening system can be employed that provides controlled release and reduced force application of the parking brake system. An example of a suitable system comprises a sealed gas filled member supplied commercially by Suspa Incorporated, Grand Rapids, Mich. as a Series 16 Gas Spring.

In one aspect of the invention, the system comprises a gas spring that functions to as a counterbalance or an accumulator when the parking brake lever travels to a disengaged position. The gas spring comprises a self-contained, hermetically-sealed hydro-pneumatic actuator. The spring typically contains pressurized nitrogen gas. Each gas spring also contains a specific amount of oil, which lubricates the seal, piston and piston rod. The oil and gas within the cylinder moves from one side of the piston head to the other when compressed or extended thereby providing a dampening effect (the fluid movement within the cylinder can be controlled either on extension, compression or both). As a result, gas springs can provide a relatively flat force curve, controlled force and extension speed, and dampening at the end of the stroke. In its unloaded static state, the piston rod within the cylinder extends outside of the gas-pressurized tube. The extended output force is a result of the difference between the internal gas pressure and the outside atmospheric pressure. As the piston is compressed, the internal pressure and output force increase according to the rod volume displaced. During rod extension, the internal pressure and output force decrease according to the reduced internal rod volume.

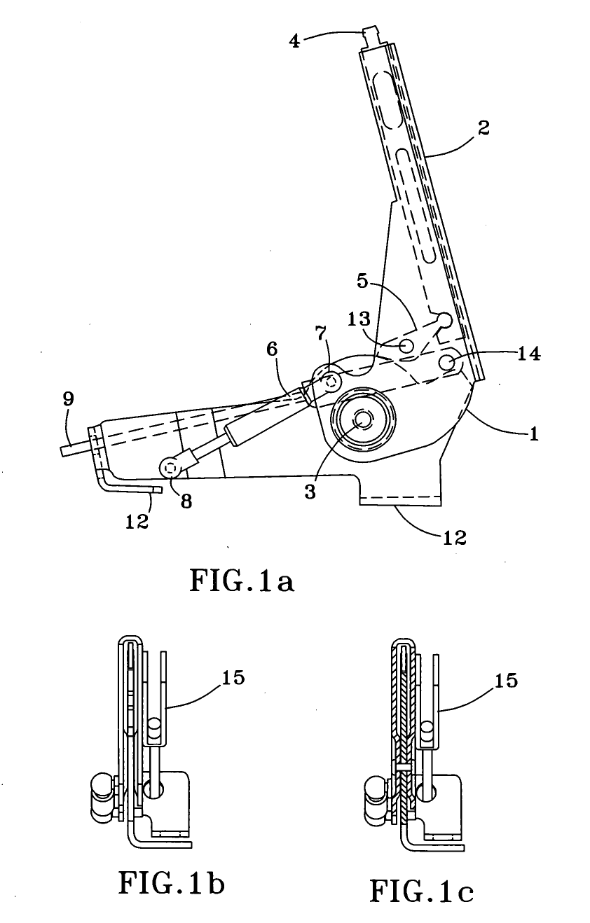

The system is located within the parking brake system in a manner sufficient to control the release of the parking brake lever into a disengaged or released position, and reduce the force necessary to displace the parking brake lever into an engaged position. The system can be located between a stationary member and pivotal lever of the parking bark system. The system can also be located on the side of the member and lever (e.g., refer to FIG. 1), attached only to the pivotal lever and a stationary member of a vehicle (e.g., floor panel, fire wall, among other stationary members), among other attachments. The system can be connected to the parking brake system by any suitable manner such as clevis, rotateable joints, pins, slots, rivets, among other fasteners known in the art.

In an aspect of the invention, the dampening system is pivotally connected to the parking brake lever of the parking brake system and a mounting bracket. The parking brake lever can be pivotally connected to a handle (for a hand operated systems), or a foot pedal lever (for foot operated systems). The handle is also pivotally connected to the mounting bracket. The distance (e.g., arcuate distance) which the parking brake lever is displaced is defines a force applied to a cable. The end of the parking brake lever associated with the cable also defines an attachment point for the cable (e.g., a clevis for receiving the cable is attached to the parking brake lever adjacent to the pin). The distal end of the cable engages a parking brake system and is engaged or disengaged in response to movement of the lever/handle.

While the system controls the rate at which the parking brake lever travels to its released position, the dampening system does not inhibit parking brake application, or complete disengagement or release of the parking brake assembly. The rate at which the parking brake lever travels to its released position is dependent upon the rate at which fluid (e.g., gas-oil) travels through the system. As the parking brake lever travels to its released position it also compresses the gas-oil within the system. This compressive force is employed (as a spring) when engaging the parking brake lever in order to reduce the amount of force necessary to displace the parking brake lever into the engaged position.

Certain aspects of the invention are better understood by reference to the drawings. Referring now to FIG. 1, FIG. 1 illustrates an aspect of the invention comprising a hand operated parking brake system, which comprises a handle, parking lever, system and mounting bracket, in an engaged position. While the illustrated parking brake system is intended to be mounted upon the floor of a vehicle, the parking brake system can be mounted at any convenient location (e.g., floor, under dash, upon dash, among other locations). One end of the parking brake lever is attached to the system and the other end is pivotally connected to a pin on the mounting bracket. The engaged position applies a tensile force upon a cable and in turn operates a parking brake. When in the engaged position, the dampening system is extended (or the rod within the gas spring as traveled outside of the cylinder).

FIGS. 1A through 1C illustrate mounting bracket 1. Mounting bracket is maintained a predetermined location within the vehicle by fasteners (not shown) inserted through suitable mounting points 12. Handle system 2 is pivotally mounted to mounting bracket 1 via pin 3. Handle system 2 comprises hand grip/button 4 that slides and is received within handle system 2. Handle system 2 is pivoted by depressing release button 4 which in turn disengages lever or pawl 5 thereby allowing handle system 2 to rotate about pin 3. Lever 5 is pivotally mounted via pin 13 between bracket 1 and lever 2. Lever 5 has teeth (not shown) that engage teeth (not shown) on mounting bracket 1 (i.e., a racket and pawl interconnection). The position of lever 2 relative to mounting bracket 1 can be controlled by the vehicle operator and is dependent upon the number of teeth in the racket/pawl interconnection and engagement with a specific tooth. Pivotal movement of handle system 2 causes operation of system 6.

System 6 is functionally connected to handle system 2 via link pin 7. System 6 is functionally connected to mounting bracket 1 via link pin 8. Rod 9 connects movement of the handle system 2 to a cable system (not shown). The movement of the cable system in turn operates a braking system (e.g., drive line, wheel-drum, among others). Rod 9 engages clevis 15 that is pivotally connected via pin 14 to lever 2.

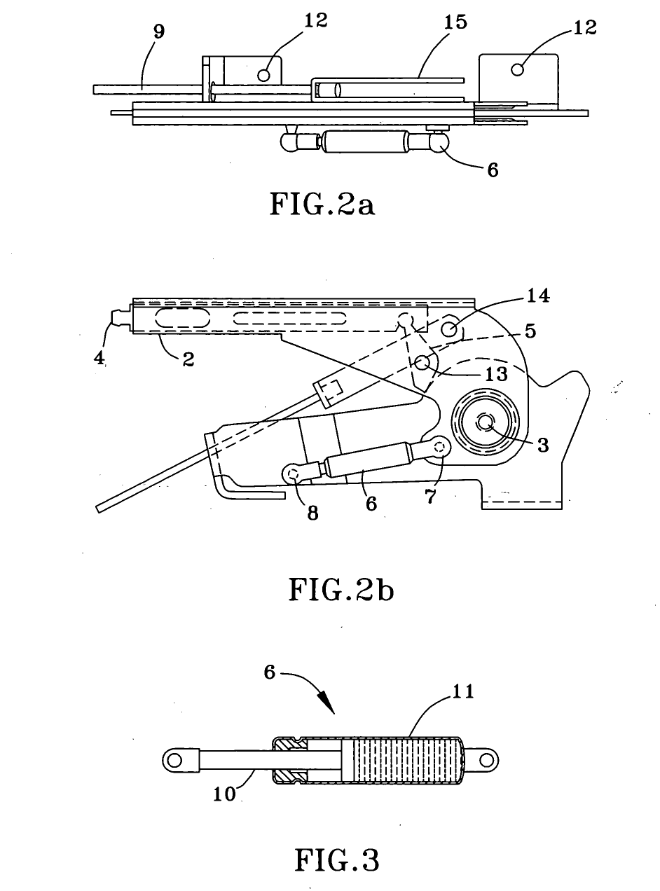

Referring now to FIG. 2, FIGS. 2A and B illustrate the parking brake system of FIG. 1 in a disengaged position. The lever 5 has been released which allows the tension in the cable to draw the parking brake lever into a disengaged position. The release (or rate at which the handle/parking brake lever pivot about the mounting bracket) is controlled by the dampening system. When in the disengaged position, the system 6 is compressed (or the rod as traveled into the cylinder). The stored compressive force within system 6 functions as a spring in order to reduce the application force while reengaging the parking brake system.

Referring now to FIGS. 3A through C, these Figures illustrate the piston or rod that can be employed in the system 6 (e.g., a pneumatic system). FIG. 3 illustrates the system 6 having rod 10 that slides and is located within cylinder 11. Cylinder 11 is pivotally connected to handle 2 and rod 10 is pivotally connected to bracket 1.

While this description emphasizes using the dampening system on a parking brake system, the inventive dampening system can be employed for virtually any application wherein it is desirable to have controlled release or application of mechanical energy or force. Non-limiting examples of such applications comprise shock absorbers, door opening devices, position adjustment components, hinge supports, among other applications.

The invention has been described with reference to certain aspects. Modifications and alterations will occur to others upon a reading and understanding of this specification. Mere reversal of components that achieve substantially the same function and result are contemplated. It is intended to include all such modifications and alterations insofar as they come within the scope of any appended claims or the equivalents thereof.

1). A hand operated lever system comprising a lever pivotally mounted on a mounting bracket and a dampening system functionally located between the lever and bracket.

2). A parking brake lever system comprising a lever pivotally mounted on a bracket and a gas containing dampening system that is compressed upon disengagement of the system and released when the system is engaged.

3) The system of claim 1 wherein the pivotally mounted lever is connected to a cable.

4) The system of claim 1 wherein at least one pawl is pivotally mounted between the lever and mounting bracket and wherein disengagement of the pawl permits the lever to pivot relative to the mounting bracket.

5) The system of claim 2 wherein the dampening system comprises a piston and cylinder.

6). The system of claim 5 wherein the cylinder is pivotally connected to lever and the piston is pivotally connected to the bracket.

7) The system of claim 3 wherein the cable comprises a parking brake cable.

8) The system of claim 1 wherein the dampening system reduces the force necessary to engage the system and reduces the rate at which the system is disengaged.
